(19) United States
(12) Patent Application Publication
(10) Pub. No.: US 2022/0144680 A1
(43) Pub. Date: May 12, 2022

(54) DRYING SYSTEM AND METHOD FOR DRYING DEWATERED SEWAGE SLUDGE

(71) Applicant: HUBER SE, Berching (DE)

(72) Inventors: Albert Heindl, Deining (DE); Dominik Friedrich, Ansbach (DE)

(21) Appl. No.: 17/524,001

(22) Filed: Nov. 11, 2021

(30) Foreign Application Priority Data
Nov. 12, 2020 (DE) 10 2020 129 822.6

(51) Int. Cl. C02F 11/13; F26B 23/10; F23G 7/00

(52) U.S. Cl. CPC C02F 11/13; F26B 2200/18; F23G 7/001; F26B 23/10

(57) ABSTRACT

A drying system includes a disk contact dryer, which includes an inlet for the sewage sludge, a drying chamber for temporarily accommodating the sewage sludge, multiple disks in the drying chamber, a drive for rotating the disks at a defined rotational speed, a heater for heating the disks, an outlet for the sewage sludge dried in the drying chamber, and an incineration system for the dried sludge. The drying system includes an input sensor for determining the initial moisture of the sewage sludge, an output sensor for determining the final moisture of the sewage sludge, and a controller for regulating the rotational speed of the disks and/or the heat output of the heater and/or the amount of sewage sludge entering the inlet, and/or the amount of dry sewage sludge exiting the outlet based on the measurements of the input sensor and of the output sensor.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a drying system for drying dewatered sewage sludge and including a disk contact dryer that includes a drying chamber for temporarily accommodating the sewage sludge to be dried and housing multiple disks arranged adjacent to one another and rotatable and heated to contact the sewage sludge during the operation of the disk contact dryer. The disks supply heat to the sewage sludge to effectuate an evaporation of the liquid present in the sewage sludge passing through the drying chamber. Moreover, an installation that combines an incineration system for incinerating the dry sewage sludge discharged from the drying system, and a method for operating a drying system, are disclosed.

### BACKGROUND OF THE INVENTION

Drying systems of the generic type are utilized for drying dewatered sewage sludge, wherein the sewage sludge generally originates from one or multiple wastewater treatment plant(s). Before the sewage sludge originating from the wastewater treatment plant is routed to the drying system, the sewage sludge is dewatered, i.e., a portion of the water contained in the sewage sludge is removed from the sewage sludge mechanically (for example, by means of appropriate pressing devices, for example, by means of a screw press) or in settling basins, and so the dry matter (also referred to as dry substance) of the sewage sludge increases, wherein dewatering within the scope of the invention does not mean that all the liquid is removed from the sewage sludge. The moisture of the sewage sludge is merely reduced during the drying, and so the dry sewage sludge according to the state of the art still has residual moisture.

The sewage sludge dewatered in this way is routed, in the drying system, via an inlet to a disk contact dryer and, thereby, enters a drying chamber of the disk contact dryer. Within the disk contact dryer, the sewage sludge comes into contact with multiple disks of the disk contact dryer, which are preferably set into rotation during the operation of the disk contact dryer with the aid of a drive (preferably in the form of an electric motor). The drive of the disks is preferably designed to be speed-controlled, in order to be able to affect the mixing quality and, thereby, the specific water evaporation within the drying chamber. The disks are acted upon by a heating medium, wherein the heating medium is, for example, hot water, steam, or a heat transfer oil. The heating medium is routed to the disks via a heating medium inlet. Within the drying chamber, the disks give off heat from the heating medium to the sewage sludge, and so the sewage sludge is heated and, in so doing, gives off steam (which can contain water as well as further chemical compounds). The steam is finally removed from the drying chamber via a vapor escape. Alternatively, it would also be conceivable to electrically heat the disks.

In the end, the water content (i.e., the moisture) of the sewage sludge is reduced within the disk contact dryer and, thereby, the dry matter is increased. The sewage sludge dried in this manner finally leaves the disk contact dryer via an outlet and can be routed to a further utilization, for example, an incineration.

In order to optimally utilize the thermal energy supplied to the disks and adjust the final moisture of the sewage sludge exiting the disk contact dryer to a desired value, it has been customary to determine the mass of the sewage sludge located in the disk contact dryer by means of load cells, which are associated with a housing surrounding the drying chamber. The mass of the sewage sludge within the drying chamber is held as constant as possible based on the data of the load cells, wherein this is brought about by regulating the amount of sewage sludge entering the drying chamber via the inlet.

Such a regulation of the mass flow rate of the sewage sludge is relatively inaccurate, however, and so the energy efficiency of the disk contact dryer is not optimal. In addition, the final moisture of the sewage sludge exiting the disk contact dryer fluctuates to an excessively great extent due to the inaccurate regulation of the disk contact dryer, which can negatively affect the further processing of the sewage sludge. For example, an incineration system installed downstream from the drying system cannot be optimally operated when the moisture, i.e., the water content, of the sewage sludge routed to the incineration system excessively fluctuates.

### EXEMPLARY OBJECTS AND SUMMARY OF THE INVENTION

The problem addressed by the present invention is therefore that of providing a drying system, a combination installation that includes both a drying system and an incineration system downstream of the drying system, as well as a method for drying sewage sludge, which advantageously refine the prior art. However, the dry sewage sludge leaving the drying system and method according to the present invention, also still has residual moisture. Aspects and advantages of the invention are set forth below in the following description, or may be obvious from the description, or may be learned by those skilled in the art through practice of embodiments of the invention disclosed herein. Those of ordinary skill in the art will better appreciate the features and aspects of such embodiments, and others, upon review of the specification.

According to the invention, the drying system is distinguished by the fact that it includes an input sensor for determining the initial moisture of the sewage sludge to be dried and an output sensor for determining the final moisture of the sewage sludge dried in the drying chamber. The sensors are therefore designed for determining either the water content or moisture or the dry matter of the sewage sludge, and so the particular initial moisture and final moisture of the sewage sludge can be determined or calculated from the measured values of the sensors.

Moreover, the drying system includes a controller, which is preferably designed for regulating the heat output and/or the rotational speed of the disks (and/or of the drive connected to the disks, for example, via a shaft) of the disk contact dryer, based on the measured data of the input sensor and of the output sensor. This is possible, for example, due to the fact that the temperature or the volumetric flow rate of the heating medium flowing into the disks, or its steam pressure (when the heating medium is steam) is regulated. It would also be possible to regulate the temperature of the disks by changing the electrical power of an electric heater heating the disks. The rotational speed can be changed by means of a frequency converter, by way of example, when an electric motor is utilized as the drive.

Additionally or alternatively, it is also possible to regulate the amount of the sewage sludge to be dried, which is entering the drying chamber via the inlet, and/or the amount of the dry sewage sludge exiting the drying chamber via the outlet based on the measured values of the input sensor and of the output sensor. Due to the regulation according to the invention, it is now possible to precisely adjust the final moisture of the sewage sludge exiting the disk contact dryer to a desired value, under consideration of its initial moisture before the drying step.

If the controller detects, for example, that the initial moisture of the sewage sludge entering the disk contact dryer increases over a certain time period, it would be conceivable, for example, to reduce the amount of sewage sludge entering the drying chamber via the inlet per unit of time and/or to increase the heat output of the disk contact dryer. Additionally or alternatively, the amount of sewage sludge exiting the drying chamber via the outlet per unit of time could also be reduced.

In the end, the controller should be designed in such a way that the final moisture of the sewage sludge exiting the disk contact dryer is always within a defined range.

It is also advantageous when the inlet is connected to an input sludge line of the drying system or to an input conveyor device of the drying system, which is utilized for transporting the sewage sludge to be dried. The input sludge line is, for example, a pipeline or a hose line, in particular a pressure line, via which the sewage sludge to be dried is connected to a storage tank or a device, with the aid of which sewage sludge is dewatered, and via which the sewage sludge is transported in the direction of the inlet, for example, with the aid of a pump.

It is also conceivable that the inlet is directly connected to an input conveyor device, wherein, alternatively, the input conveyor device can also be integrated into the input sludge line or connected thereto and, thereby, is not arranged directly in the area of the inlet. The input conveyor device is a device, with the aid of which the sewage sludge is actively transported in the direction of the inlet and into the drying chamber. Preferably, the input conveyor device is an input screw conveyor. A piston pump, an eccentric screw pump, or a comparable conveyor device can also be utilized. The input conveyor device can also be designed as a conveyor belt.

It is also advantageous when the outlet is connected to an output sludge line of the drying system or to an output conveyor device of the drying system, which is utilized for transporting the dried sewage sludge, wherein the output conveyor device is designed, in particular, as an output screw conveyor. The output sludge line can be designed as a pipeline or a hose line. The output conveyor device can be designed comparably to the input conveyor device and is either integrated into the output sludge line or is connected thereto or is located in the area of the outlet of the disk contact dryer.

It is also advantageous for a good function of the disk contact dryer, with respect to a maximum energy recovery from the condensation of the vapors withdrawn via the vapor escape, that the air leakage into the drying chamber is minimized. This can be achieved, for example, by the use of self-sealing piston pumps or by specific screw conveyors with plug flow formation due to omitted turns of the screw.

Moreover, it is advantageous when the drying system includes an input storage tank for the temporary storage, before the drying process, of the sewage sludge to be dried. In the event of minor interruptions in the operation of the unit (for example, in the form of an incineration system) installed downstream from the drying system, the dried sewage sludge can therefore be temporarily stored, without the need to shut down the disk contact dryer. The input storage tank is, for example, a sewage sludge bunker, in which a certain amount of sewage sludge to be dried is temporarily stored until it is routed to the disk contact dryer. The input storage tank is connected to the drying chamber via the input sludge line or the input conveyor device. Additionally or alternatively, it is also advantageous when the drying system includes an output storage tank for temporarily storing the dried sewage sludge before further processing, for example, in an incineration system or a further drying device.

It is also advantageous when the output storage tank includes a storage-tank conveyor device, in particular a storage-tank screw conveyor, via which the dried sewage sludge enters the output storage tank during the operation of the drying system. The storage-tank conveyor device can be connected, for example, to the output sludge line. It is also advantageous when the storage-tank conveyor device empties directly into the output storage tank.

The storage-tank conveyor device is preferably connected to a drive, and so the mass flow rate of the dried sewage sludge can be regulated via the regulation of the drive. The storage-tank conveyor device can also include a tubular screw conveyor, which is mounted, in particular, in an overhung manner and pushes the sewage sludge, as a plug, through an annularly designed output sensor at the end of the pipe, without blocking. The pipe diameter is, for example, between 100 mm and 300 mm. The tubular screw conveyor can be arranged in the drop area of the sewage sludge after the output conveyor device of the disk contact dryer, and so a representative sample of the sewage sludge exiting the drying chamber is always and promptly analyzed with respect to its final moisture. The analyzed sewage sludge is finally transferred into the output storage tank.

It is particularly advantageous when the output sensor is arranged in the area of the storage-tank conveyor device, wherein the storage-tank conveyor device is designed, for example, as a screw conveyor, as a conveyor belt, as a piston pump, or as an eccentric screw pump. The output sensor is arranged, for example, in the area of a sewage sludge output of the storage-tank conveyor device. In particular, the output sensor can surround the sewage sludge output, preferably annularly, and so the sewage sludge flows through the output sensor. Preferably, the output sensor comes into direct contact with the sewage sludge.

Moreover, it is advantageous when the input sensor is arranged in the area of the inlet, in the area of the input sludge line, in the area of the input conveyor device, or in the area of the input storage tank. Additionally or alternatively, it is advantageous when the output sensor is arranged in the area of the outlet, in the area of the output sludge line, in the area of the output conveyor device, or in the area of the output storage tank.

It is also advantageous when the input sensor and/or the output sensor are/is designed as a microwave sensor or a near-infrared sensor. In particular, one or both sensor(s) should be designed as a contactless sensor, i.e., the sensor is located at a point, at which it does not directly come into contact with the sewage sludge. For example, the appropriate sensor can be spatially separated from the sewage sludge via a sheet of glass or any other spatial separation. In particular, it is advantageous when the microwave sensor is annularly located around the input sludge line or the output sludge line, and so the sewage sludge must flow through the microwave sensor.

The composite according to the invention includes a drying system, in particular having one or several of the above-described feature(s), and an incineration system installed downstream from the drying system, with the aid of which the previously dried sewage sludge can be incinerated. Moreover, the composite includes a control unit, which is designed for regulating the rotational speed of the disks and/or the heat output and/or the amount of the sewage sludge to be dried, which is entering the drying chamber of the disk contact dryer via the inlet, and/or the amount of the dried sewage sludge exiting the drying chamber via the outlet of the disk contact dryer based on the measured data of the input sensor and of the output sensor and under consideration of one or multiple process variable(s) of the incineration system.

With respect to the heat output and/or the amount of the sewage sludge to be dried, which is entering the drying chamber of the disk contact dryer via the inlet, and/or the amount of the dried sewage sludge exiting the drying chamber via the outlet of the disk contact dryer, reference is made to the preceding description and the following description.

Due to the additional taking into account of one or multiple process variable(s) of the incineration system, it is finally possible to optimally adapt the operation of the drying system to the incineration process in the incineration system, and so the energy efficiency of the drying system and/or of the incineration system can be maximized.

A further process variable that could be taken into account is, for example, the mass flow rate of the sewage sludge routed to the incineration system. If the mass flow rate is, for example, increased, it is advantageous to also increase the heat output of the disk contact dryer and to also increase the mass flow rate of the sewage sludge entering the disk contact dryer and/or of the sewage sludge exiting the disk contact dryer. An opposite adaptation can be advantageous for the case in which the mass flow rate of the sewage sludge routed to the incineration system is reduced.

The method according to the invention is distinguished by the fact that the rotational speed of the disks and/or the heat output and/or the amount of the sewage sludge to be dried, which is entering the drying chamber, and/or the amount of the dried sewage sludge exiting the drying chamber are/is regulated based on the initial moisture of the sewage sludge to be dried and the final moisture of the dried sewage sludge.

In contrast to the prior art, in the method according to the invention, both the initial moisture as well as the final moisture are therefore taken into account during the operation of the drying system. In the end, it is therefore possible to optimally operate the disk contact dryer, since multiple parameters are available, via which the ratio of heat output and the sewage sludge passing through the disk contact dryer can be adapted.

For example, it would be conceivable to increase the heat output of the disk contact dryer and/or the rotational speed of the disks when the initial moisture increases. The heat output or the rotational speed of the disks could also be decreased when the initial moisture decreases. If the heat output is to remain constant, it would also be conceivable to reduce the mass flow rate of the sewage sludge entering the drying chamber when its initial moisture increases, or to increase the mass flow rate when the initial moisture of the sewage sludge entering the drying chamber decreases over time. Additionally or alternatively, an appropriate regulation of the mass flow rate of the sewage sludge exiting the disk contact dryer is also conceivable (increasing the mass flow rate in the case of a higher heat output or a lower initial moisture, or decreasing the mass flow rate in the case of a lower heat output or a higher initial moisture).

It is also advantageous when the heat output and/or the amount of the sewage sludge to be dried, which is entering the drying chamber, and/or the amount of the dried sewage sludge exiting the drying chamber via the outlet are/is regulated in such a way that the dried sewage sludge has a final moisture, the amount of which is between 52% and 62% moisture, preferably between 55% and 60% moisture. An amount of less than 62% moisture ensures that the dried sewage sludge can be incinerated in a downstream incineration system. The incineration system, within the scope of the invention (i.e., also in conjunction with the drying system according to the invention and with the above-described composite), is preferably a fluidized-bed incineration system. Simultaneously, it is advantageous when the final dried substance is not arbitrarily reduced during the partial drying. In particular, this should be less than 0%, preferably less than 45%. This ensures that the sewage sludge within the disk contact dryer does not reach its paste phase, since reaching the paste phase could result in a blockage of the disk contact dryer (sewage sludge has extremely sticky properties in the range from 40% to 55% dry substance or from 45% to 60% moisture; this range is referred to as the paste phase).

In one alternative embodiment, it is also conceivable that the sewage sludge is dried within the drying chamber to a final moisture, the amount of which is less than 20% moisture, preferably between 2% and 20% moisture, preferably between 5% and 10% moisture (this is referred to as full drying). In this case, however, so much dried sewage sludge is to be admixed with the sewage sludge entering the drying chamber via the inlet, as a function of its initial moisture, that the initial moisture of the mixture is less than 40%, in order to prevent the mixture from having a moisture during the drying process that is in the range of the paste-phase moisture. For example, it would be conceivable to dry the mixture to a final moisture of 10% and admix a portion of the dried mixture with dewatered sewage sludge, in order to obtain a mixture again, the initial moisture of which is less than 40%.

It is also advantageous when the initial moisture is measured in the area of an inlet of the disk contact dryer, in the area of an input sludge line connected to the inlet, in the area of an input conveyor device connected to the inlet, or in the area of an input storage tank connected to the inlet. Additionally or alternatively, the final moisture can be measured in the area of an outlet of the disk contact dryer, in the area of an output sludge line connected to the outlet, in the area of an output conveyor device connected to the outlet, in the area of an output storage tank connected to the outlet, or in the area of a storage-tank conveyor device of the output storage tank. Reference is made to the preceding description and to the following description in this context as well.

In particular, it is advantageous when a drying system according to the preceding description and/or to the following description is utilized in the method. The drying system according to the invention can also be designed to be operated according to the described method.

### BRIEF DESCRIPTION OF THE DRAWINGS

The accompanying drawings, which are incorporated in and constitute a part of this specification, illustrate at least one presently preferred embodiment of the invention as well as features applicable to some alternative embodiments. These drawings, together with the written description, explain the principles of the invention but by no means are intended to be exhaustive of every possible embodiment of the invention. A full and enabling disclosure of the present invention is set forth more particularly in this specification, including reference to the accompanying figures, in which:

FIG. 1 schematically shows a drying system according to the invention.

FIG. 2 schematically shows details of components of a drying system according to the invention.

### DETAILED DESCRIPTION OF EXEMPLARY EMBODIMENTS OF THE INVENTION

Reference now will be made in detail to present exemplary embodiments of the invention, wherein one or more examples of which are illustrated in the accompanying drawings. The detailed description uses numerical and/or letter designations to refer to features in the drawings. Like or similar designations in the drawings and description have been used to refer to like or similar parts of the embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 100 to 1200 also includes all possible sub-ranges, examples of which are from 100 to 150, 170 to 190, 153 to 162, 145.3 to 149.6, and 187 to 1200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

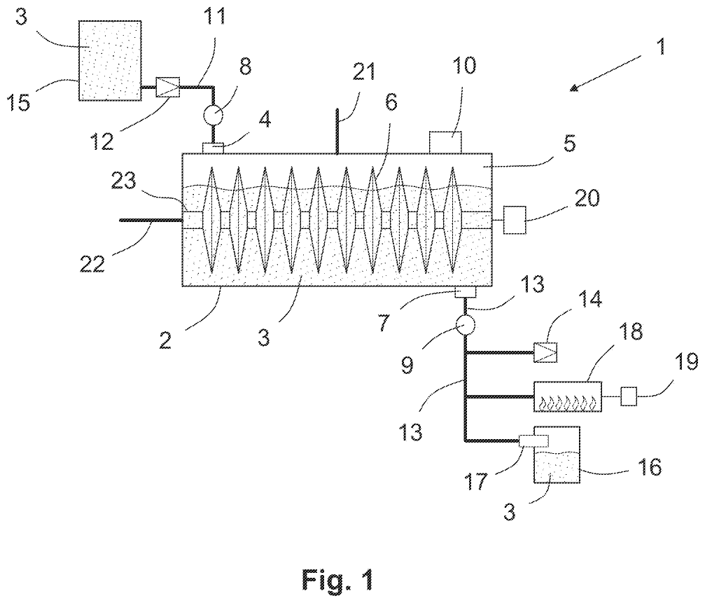

FIG. 1 schematically shows a drying system 1 according to the invention for drying sewage sludge 3. The drying system 1 includes a disk contact dryer 2 having a drying chamber 5 and a plurality of disks 6 arranged within the drying chamber 5. The disks 6 are arranged adjacent to one another within the drying chamber 50 and disposed to come in contact with the partially dewatered sewage sludge 3 during the operation of the disk contact dryer 2. The disks 6 desirably are connected to an exterior surface that defines a shaft 23, which extends axially along the length of the drying chamber 5. A drive 20 is connected to the shaft 23 and configured for rotating the shaft 23 and the plurality of disks 6 during the operation of the disk contact dryer 2 in order to optimize the heat transfer from the disks 6 to the sewage sludge 3.

A heater is configured to act upon the disks 6 with a predefined heating power to supply heat to the partially dewatered sewage sludge 3 to be dried and effectuate an evaporation of liquid present in the partially dewatered sewage sludge 3 to be dried to yield dried sewage sludge. In order to heat the disks 6, the disks 6 desirably are connected to a heating medium inlet 22 schematically shown in FIG. 1. A heated liquid, for example, water or a heat transfer oil, or heated steam, desirably is supplied via the interior of the shaft 23 to the interior of the disks 6 in order to heat the disks 6. The moisture emerging from the sewage sludge 3 during the drying process finally reaches the outside of the drying chamber 5 via a vapor escape 21.

Moreover, as schematically shown in FIG. 1, the disk contact dryer 2 includes an inlet 4 connected to the drying chamber 5 and configured for receiving partially dewatered sludge 3 to be dried that enters the drying chamber 5. The disk contact dryer 2 includes an outlet 7 connected to the drying chamber 5 and configured for the receiving sewage sludge that has been dried in the drying chamber 5 and discharging of the dried sewage sludge exiting from the drying chamber 5.

As schematically shown in FIG. 1, the inlet 4 in the exemplary embodiment shown is connected via an input sludge line 11 to an input storage tank 15, in which the sewage sludge 3 to be dried is stored for the drying process that is to occur within the drying chamber 5. In the example shown, the drying system 1 includes an input conveyor device 12, which is configured to transport the sewage sludge 3 from the input storage tank 15 into the drying chamber 5 via the input sludge line 11.

Alternatively, the input storage tank 15 can also be omitted when the sewage sludge 3 to be dried is continuously transported to the disk contact dryer 2, for example, via a conveyor device, which is connected to a device delivering the sewage sludge 3.

The outlet 7 in the exemplary embodiment shown schematically in FIG. 1 is connected to an output sludge line 13. The dried sewage sludge 3 is discharged from the drying chamber 5 via the output sludge line 13. An output conveyor device 14 desirably is connected to the output sludge line 13 and configured to transport the dried sewage sludge 3 to a further device, in which the dried sewage sludge 3 is further processed.

It is also conceivable that the output conveyor device 14 is utilized for conveying the dried sewage sludge 3 into an output facility (not represented) of the drying system 1, from which output facility the dried sewage sludge 3 is transported away.

Moreover, as schematically shown in FIG. 1, the output sludge line 13 can empty into an incineration system 18, wherein a conveyor device for the sewage sludge 3 also could be present in this region of the output sludge line 13.

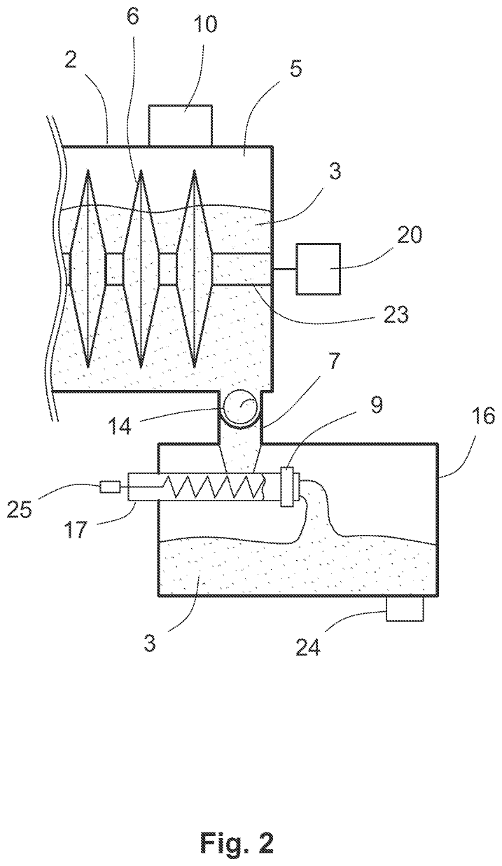

Additionally, as schematically shown in FIG. 1, it is conceivable that the output sludge line 13 empties into an output storage tank 16, which is a hopper that is configured and disposed to be utilized for temporarily storing the dried sewage sludge 3. According to this embodiment, it is advantageous when the output storage tank 16 includes a storage-tank conveyor device 17, which ensures a movement of the sewage sludge 3 from the output sludge line 13 into the output storage tank 16. One further advantage of the storage-tank conveyor device 17 is described further below in conjunction with FIG. 2.

The described devices (output conveyor device 14, incineration system 18, output storage tank 16) can be present individually or in any combination in the drying system 1 according to the invention, wherein the combination of the drying system 1 and the incineration system 18 would form a combined installation according to the invention. In this case, as schematically shown in FIG. 1, the combined installation and/or the incineration system 18 alone can include a separate control unit 19, with the aid of which separate control unit 19, the incineration of the dried sludge 3 can be performed.

In order to be able to reliably regulate the drying process of the sewage sludge 3 within the drying chamber 5, the drying system 1 includes an input sensor 8 that is configured and disposed for measuring the initial moisture of the sewage sludge 3 entering the drying chamber 5. Additionally, the drying system 1 includes an output sensor 9 that is configured and disposed for determining the final moisture of the dried sewage sludge 3 at or after the outlet 7. With respect to possible sensors 8, 9, reference is made to the preceding description.

In particular, it is advantageous when the input sensor 8 is integrated into the input sludge line 11. It likewise is advantageous when the output sensor 9 is integrated into the output sludge line 13.

Both the input sensor 8 and the output sensor 9 are connected to a controller 10. The controller 10 is configured to evaluate the measured data of the sensors 8, 9. The controller is further configured to employ the measured data from one or both of the sensors 8, 9 as a basis of regulating the heat output of the disk contact dryer 2 and/or the mass flow rate of the sewage sludge 3 entering the drying chamber 5 via the inlet 4 and/or the mass flow rate of the sewage sludge 3 exiting the drying chamber 5. Thus, as schematically shown in FIG. 1, the controller 10 desirably is connected to and configured to control operation of the input conveyor device 12 and the output conveyor device 14. Moreover, the controller 10 desirably is connected to and configured to control operation of the device supplying the heat via the heating medium inlet 22. The controller 10 desirably is connected to and configured to control operation of the drive 20 that is connected to the shaft 23 and configured for rotating the shaft 23 and the plurality of disks 6 during the operation of the disk contact dryer 2 in order to optimize the heat transfer from the disks 6 to the sewage sludge 3.

For example, it would be possible, furthermore, that the aforementioned control unit 19 regulates the oxygen supply and/or the air supply of the incineration system 18 based on the data of the input sensor 8 and/or of the output sensor 9. In particular, the control unit 19 can be directly connected to the aforementioned sensors 8, 9, and a connection to a controller 10 of the drying system 1 is also contemplated.

FIG. 2 schematically shows one alternative to the embodiment in FIG. 1, in which the disk contact dryer 2 is connected to an output storage tank 16, wherein only one section of the drying system 1 is represented. The disk contact dryer 2 includes, in the vicinity of its outlet 7, an output conveyor device 14 that is configured to route the dried sewage sludge 3 out of the drying chamber 5 and into a storage-tank conveyor device 17. The controller 10 desirably is connected to and configured to control operation of the storage-tank conveyor device 17 and the output conveyor device 14. In the view schematically depicted in FIG. 2, the output conveyor device 14 desirably is provided in the form of a screw conveyor, which is depicted from the perspective of a plane that is normal to the axis of rotation of the screw.

The storage-tank conveyor device 17 in the example shown includes a screw conveyor, which is connected to a drive unit 25. In the view schematically depicted in FIG. 2, the storage-tank conveyor device 17 is depicted from the perspective of a plane that is parallel to the axis of rotation of the screw. With the aid of the screw conveyor of the storage-tank conveyor device 17, the sewage sludge 3 coming from the drying chamber 5 is transported into the output storage tank 16. In this embodiment, the output sensor 9 is preferably annularly located around the storage-tank conveyor device 17 so that the output sensor 9 is disposed for determining the moisture content of the sewage sludge 3 passing through the storage-tank conveyor device 17. In a further alternative embodiment, a portion of the sewage sludge 3 emerging from the outlet 7 can also flow past or fall past the storage-tank conveyor device 17 into the output storage tank 16, and so only a portion of the aforementioned dried sewage sludge 3 is conveyed by the storage-tank conveyor device 17.

In particular, the output sensor 9 in the examples shown is designed as a microwave sensor, with the aid of which the final moisture of the sewage sludge 3 can be determined. As a result, a particularly reliable measurement of the final moisture of the sewage sludge 3 is possible, since the sewage sludge 3 is transported by the storage-tank conveyor device 17 at a constant and predictable mass flow rate.

While at least one presently preferred embodiment of the invention has been described using specific terms, such description is for illustrative purposes only. It is to be understood that changes and variations may be made without departing from the spirit or scope of the following claims. This written description uses examples to disclose the invention, and also to enable any person skilled in the art to practice the invention, including making and using any devices or systems and performing any incorporated methods. The patentable scope of the invention is defined by the claims, and may include other examples that the present disclosure puts into the possession of those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A drying system for drying partially dewatered sewage sludge, the drying system comprising:
a disk contact dryer that includes an inlet configured for receiving the partially dewatered sewage sludge that is to be dried, a drying chamber adjoining the inlet and connected to the inlet and configured for temporarily accommodating the partially dewatered sewage sludge to be dried that has been received via the inlet, a plurality of disks, which are arranged adjacent to one another within the drying chamber and disposed to come in contact with the partially dewatered sewage sludge during the operation of the disk contact dryer, and an outlet connected to the drying chamber and configured for receiving sewage sludge dried in the drying chamber to exit from the drying chamber;
a drive connected to the disk contact dryer and configured for rotating the plurality of disks at a predefined rotational speed;
a heater configured to act upon the disks with a predefined heating power to supply heat to the partially dewatered sewage sludge to be dried and effectuate an evaporation of liquid present in the partially dewatered sewage sludge to be dried to yield dried sewage sludge; and
an input sensor configured for determining an initial measure of the moisture of the partially dewatered sewage sludge to be dried;
an output sensor configured for determining a final measure of the moisture of the dried sewage sludge in the drying chamber;
a controller connected to the input sensor and to the output sensor and configured for regulating the rotational speed of the plurality of disks and the amount of partially dewatered sewage sludge to be dried entering the drying chamber via the inlet based on the initial measure of the input sensor and the final measure of the output sensor.

2. The drying system of claim 1, further comprising an input screw conveyor connected to the inlet and configured for transporting partially dewatered sewage sludge through the inlet and into the drying chamber.

3. The drying system of claim 1, further comprising an output screw conveyor connected to the outlet and configured for transporting the dried sewage sludge away from the outlet.

4. The drying system of claim 1, further comprising an output hopper connected to the outlet and configured for the intermediate storage of the dried sewage sludge exiting through the outlet before further processing of the dried sewage sludge.

5. The drying system of claim 4, wherein the output hopper includes a hopper screw conveyor that is configured to transport at least a portion of the dried sewage sludge from the outlet and into the output hopper during the operation of the drying system.

6. The drying system of claim 4, wherein the output sensor is disposed to measure the moisture of the dried sewage sludge in the output hopper during the operation of the drying system.

7. The drying system of claim 4, wherein the output sensor is arranged near the outlet or near the output hopper.

8. The drying system claim 1, wherein the input sensor or the output sensor is a microwave sensor or a near-infrared sensor.

9. The drying system of claim 1, further comprising an input hopper connected between the inlet and the drying chamber and configured for the intermediate storage, before drying, of the partially dewatered sewage sludge to be dried.

10. The drying system of claim 9, wherein the input sensor is disposed to measure the moisture of the partially dewatered sewage sludge near the inlet or near the input hopper.

11. The drying system of claim 1, wherein the controller is connected to the heater and configured for regulating the heat supplied by the heater to the plurality of disks within the drying chamber.

12. The drying system of claim 1, further comprising an incineration system connected to the disk contact dryer and configured for incinerating the dried sewage sludge from the drying chamber;
wherein the incineration system is configured for operating according to multiple process variables, wherein the incineration system is connected to the controller, which is configured for regulating the multiple process variables of the operation of the incineration system.

13. A method for operating a drying system that includes a disk contact dryer having a drying chamber for drying partially dewatered sewage sludge, and having a plurality of disks arranged adjacent to one another within the drying chamber and rotatable at a defined rotational speed, which disks are in contact with the sewage sludge during the operation of the disk contact dryer, the method comprising the steps of:
using an input sensor to determine the initial moisture of the partially dewatered sewage sludge before entry of the partially dewatered sewage sludge into the drying chamber;
introducing an amount of partially dewatered sewage sludge into the drying chamber;
applying a defined heating power to the plurality of disks to supply heat to the partially dewatered sewage sludge to effectuate an evaporation of the liquid from the partially dewatered sewage sludge introduced into the drying chamber and transform the partially dewatered sewage sludge to dried sewage sludge;
removing the dried sewage sludge from the drying chamber;
using an output sensor to determine the final moisture of the dried sewage sludge removed from the drying chamber; and
regulating the rotational speed of the disks and the amount of the partially dewatered sewage sludge introduced into the drying chamber based on the initial moisture of the sewage sludge to be dried and the final moisture of the dried sewage sludge.

14. The method of claim 13, wherein the defined heating power and the amount of the partially dewatered sewage sludge introduced into the drying chamber is regulated in such a way that the dried sewage sludge has a final moisture between 55% and 60% moisture.

15. The method of claim 13, wherein the defined heating power and the amount of the partially dewatered sewage sludge introduced into the drying chamber is regulated in such a way that the dried sewage sludge has a final moisture between 5% and 10% moisture.

16. The method of claim 13, further comprising the step of regulating the defined heating power applied to the plurality of disks in addition to the step of regulating the rotational speed of the disks and the amount of the partially dewatered sewage sludge introduced into the drying chamber based on the initial moisture of the sewage sludge to be dried and the final moisture of the dried sewage sludge.
